(19) United States
(12) Patent Application Publication
(10) Pub. No.: US 2025/0070325 A1
(43) Pub. Date: Feb. 27, 2025

(54) RECHARGEABLE BATTERY AND MANUFACTURING METHOD THEREOF

(71) Applicant: SAMSUNG SDI CO., LTD., Yongin-si (KR)

(72) Inventor: Kyugil CHOI, Yongin-si (KR)

(21) Appl. No.: 18/679,765

(22) Filed: May 31, 2024

(30) Foreign Application Priority Data
Aug. 24, 2023 (KR) 10-2023-0111554

(51) Int. Cl. H01M 50/105; H01M 10/04; H01M 50/54

(52) U.S. Cl. CPC H01M 50/105; H01M 10/0431; H01M 50/54

(57) ABSTRACT

A rechargeable battery includes an electrode assembly including a first electrode and a second electrode stacked with a separator in between, and wound into a flat jelly roll, and a case having a receiver for accommodating the electrode assembly and a sealing portion surrounding the receiver, wherein an edge of the receiver includes a first straight portion and a first curved portion connected to the first straight portion and positioned at a corner, wherein an edge of the first electrode on a plane of the electrode assembly includes a second straight portion, and a corner deformed portion connected to the second straight portion and facing the first curved portion, and wherein a minimum interval between the first curved portion and the corner deformed portion is smaller than an interval between the first straight portion and the second straight portion.

### CROSS-REFERENCE TO RELATED APPLICATION

This application claims priority to and the benefit of Korean Patent Application No. 10-2023-0111554 filed at the Korean Intellectual Property Office on Aug. 24, 2023, the entire contents of which are incorporated herein by reference.

### BACKGROUND

### 1. Field

Embodiments of the present disclosure relate to a rechargeable battery. More particularly, embodiments of the present disclosure relate to a structure of an electrode assembly and a case for increasing capacity and a manufacturing method thereof.

### 2. Description of the Related Art

Rechargeable batteries are used for a variety of purposes, such as power for small electronic devices such as mobile phones and laptop computers, and power for driving motors for transportation vehicles such as electric vehicles and hybrid vehicles. A rechargeable battery basically includes an electrode assembly and a case that seals the electrode assembly, and may be classified into cylindrical batteries, prismatic batteries, and pouch-type batteries depending on the external shape.

Since the pouch-type battery has a structure in which the edges of the case are sealed by thermal fusion, the electrode assembly is maintained at a predetermined distance from the sealed part of the case to avoid heat damage. It would be desirable to increase battery capacity while still protecting the electrode assembly.

### SUMMARY

Embodiments include a rechargeable battery. The rechargeable battery includes an electrode assembly, the electrode assembly including a first electrode and a second electrode stacked with a separator in between, and wound into a flat jelly roll, and a case having a receiver for accommodating the electrode assembly and a sealing portion surrounding the receiver, wherein an edge of the receiver includes a first straight portion and a first curved portion connected to the first straight portion and positioned at a corner, wherein an edge of the first electrode on a plane of the electrode assembly includes a second straight portion, and a corner deformed portion connected to the second straight portion and facing the first curved portion, and wherein a minimum interval between the first curved portion and the corner deformed portion is smaller than an interval between the first straight portion and the second straight portion.

The first straight portion may include a first horizontal portion and a first longitudinal portion, the second straight portion may include a second horizontal portion and a second longitudinal portion, and the receiver and the first electrode may satisfy conditions including:

D2>D3>D1,

wherein D1 is a minimum interval between the first curved portion and the corner deformed portion, D2 is an interval between the first horizontal portion and the second horizontal portion, and D3 is an interval between the first longitudinal portion and the second longitudinal portion.

The corner deformed portion may include a second curved portion, and a curvature of the second curved portion may be larger than a curvature of the first curved portion.

An edge of the second electrode on the plane of the electrode assembly may include a third curved portion positioned inside the second curved portion.

The corner deformed portion may include a first diagonal portion.

An edge of the second electrode on the plane of the electrode assembly may include a second diagonal portion positioned inside the first diagonal portion.

The first electrode may include a first substrate, the first substrate may include a plurality of flat portions and a plurality of curved portions positioned alternately one by one along a length direction, and the corner deformed portion may be positioned on at least two corners of each of the plurality of flat portions.

A first electrode tab may be connected to each of the plurality of flat portions, and the corner deformed portion may be provided at two corners positioned with the first electrode tab in between.

The corner deformed portion may be positioned at four corners of each of the plurality of flat portions.

On the plane of the electrode assembly, the separator may have a height greater than each of the first electrode and the second electrode, the separator surrounding the edge of the first electrode and an edge of the second electrode.

Embodiments include a method of manufacturing a rechargeable battery. The method includes manufacturing a first electrode in which a first metal foil is processed into a first substrate having a plurality of first electrode tabs and a plurality of first corner deformed portions by laser cutting, and a first composite material layer is formed on both surfaces of the first substrate to form the first electrode, manufacturing a second electrode in which a second metal foil is processed into a second substrate having a plurality of second electrode tabs and a plurality of second corner deformed portions by laser cutting, and a second composite material layer may be on both surfaces of the second substrate to form the second electrode, manufacturing an electrode assembly in which the first electrode and the second electrode are stacked with a separator in between and then wound to form the electrode assembly, and assembling a case in which the electrode assembly is accommodated in a receiver of the case and the case is sealed.

In manufacturing the first electrode, the first substrate may include a plurality of flat portions and a plurality of curved portions positioned alternately one by one along a length direction, and the plurality of first electrode tabs and the plurality of first corner deformed portions may be positioned in each of the plurality of flat portions.

In manufacturing the second electrode, the second substrate may include a plurality of flat portions and a plurality of curved portions positioned alternately one by one along a length direction, and the plurality of second electrode tabs and the plurality of second corner deformed portions may be positioned in each of the plurality of flat portions.

In assembling the case, an edge of the receiver may include a first straight portion and a first curved portion connected to the first straight portion and positioned at the edge, an edge of the first electrode on a plane of the electrode assembly may include a first corner deformed portion and a second straight portion connected to the first corner deformed portion, and the electrode assembly may be accommodated in the receiver so that the first corner deformed portion faces the first curved portion at an interval.

In manufacturing the first electrode, the first corner deformed portion may include one of a second curved portion and a first diagonal portion, and in assembling the case, a minimum interval between the first curved portion and the first corner deformed portion may be smaller than the interval between the first straight portion and the second straight portion.

In manufacturing the second electrode, the second corner deformed portion may include one of a third curved portion and a second diagonal portion, and an edge of the second electrode may be positioned inside the edge of the first electrode on the plane of the electrode assembly.

### BRIEF DESCRIPTION OF THE DRAWINGS

Features will become apparent to those of ordinary skill in the art by describing in detail exemplary embodiments with reference to the attached drawings, in which:

FIG. 1 is a plan view of a rechargeable battery according to one or more embodiments;

FIG. 2 is an exploded perspective view of a rechargeable battery shown in FIG. 1 according to one or more embodiments;

FIG. 3 is an enlarged view of a region A shown in FIG. 2 according to one or more embodiments;

FIG. 4 is a plan view of an electrode assembly shown in FIG. 2 according to one or more embodiments;

FIG. 5 is a plan view showing an unfolded state of a first electrode among an electrode assembly shown in FIG. 4 according to one or more embodiments;

FIG. 6 is a plan view showing an unfolded state of a second electrode among an electrode assembly shown in FIG. 4 according to one or more embodiments;

FIG. 7 is a partial enlarged view of a case and a first electrode of a rechargeable battery shown in FIG. 2 according to one or more embodiments;

FIG. 8 is a partial enlarged view of a rechargeable battery according to a comparative example according to one or more embodiments;

FIG. 9 is a plan view of an electrode assembly among rechargeable batteries according to one or more embodiments;

FIG. 10 is a plan view showing an unfolded state of a first electrode among an electrode assembly shown in FIG. 9 according to one or more embodiments;

FIG. 11 is a plan view showing an unfolded state of a second electrode among an electrode assembly shown in FIG. 9 according to one or more embodiments;

FIG. 12 is a partial enlarged view of a case and a first electrode of a rechargeable battery according to one or more embodiments; and

FIG. 13 is a flowchart showing a manufacturing method of a rechargeable battery according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout.

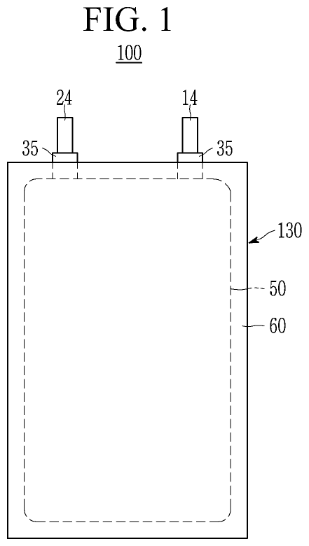

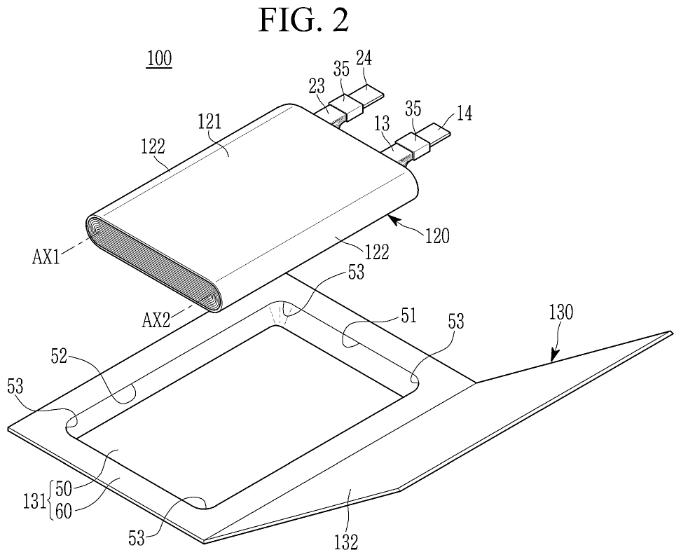

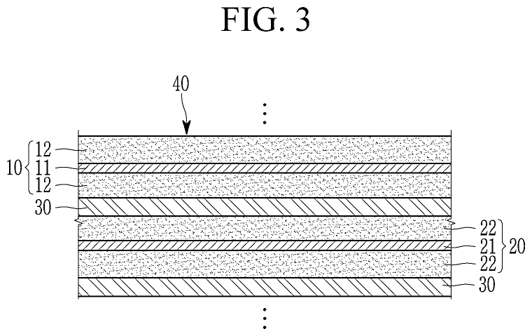

FIG. 1 is a plan view of a rechargeable battery according to one or more embodiments. FIG. 2 is an exploded perspective view of a rechargeable battery shown in FIG. 1 according to one or more embodiments. FIG. 3 is an enlarged view of a region A shown in FIG. 2 according to one or more embodiments.

Referring to FIG. 1 to FIG. 3, a rechargeable battery 100 may include an electrode assembly 120 and a pouch-shaped case 130 that accommodates and seals the electrode assembly 120 along with an electrolyte.

The case 130 may include a lower case 131 including a receiver 50 and an upper case 132 integrally connected to the lower case 131. The receiver 50 may include a concave space provided in the lower case 131 to accommodate the electrode assembly 120. An edge of the receiver 50 may be formed by a combination of first straight portions 51 and 52 and a first curved portion 53. The first straight portions 51 and 52 may include a first horizontal portion 51 and a first longitudinal portion 52. The first curved portion 53 may be positioned at four corners of the receiver 50.

The electrode assembly 120 may include a first electrode 10, a second electrode 20, and a separator 30. The separator 30 may be positioned between the first electrode 10 and the second electrode 20 and may insulate them. The first electrode 10, the second electrode 20, and the separator 30 may be configured in the shape of a long band, and may be wound around two winding axes AX1 and AX2, creating the appearance of a flat jelly roll.

For example, the first electrode 10, the separator 30, and the second electrode 20 may be sequentially stacked to form a laminate 40, and the laminate 40 may be wound around a center of the first winding axis AX1 and a center of the second winding axis AX2 positioned at a distance from each other. In other words, the laminate 40 may be continuously and alternately wound with the first winding axis AX1 and the second winding axis AX2.

Depending on the winding of the laminate 40, the external shape of the electrode assembly 120 may include a central portion 121 of a flat rectangle and a pair of rounded portions 122 positioned on both sides of the central portion 121. The central portion 121 may be a flat portion of a certain thickness positioned between the first winding axis AX1 and the second winding axis AX2. The pair of rounded portions 122 may be semicircular curved portions surrounding each of the first winding axis AX1 and the second winding axis AX2.

The first electrode 10 may include a first substrate 11, a first composite material layer 12 positioned on the first substrate 11, and a first electrode tab 13 protruded from the first substrate 11 to one side. The second electrode 20 may include a second substrate 21, a second composite material layer 22 positioned on the second substrate 21, and a second electrode tab 23 protruded from the second substrate 21 to one side. A first lead tab 14 may be attached to the first electrode tab 13, and a second lead tab 24 may be attached to the second electrode tab 23.

In a lithium-ion rechargeable battery, the first substrate 11 may include a copper foil or a nickel foil, and the first composite material layer 12 may include carbon material such as graphite, a conductive material, and a binder. The second substrate 21 may include aluminum foil, and the second composite material layer 22 may include a transition metal oxide such as LiCoO₂, LiNiO₂, LiMn₂O₄, a conductive material, and a binder. The first electrode 10 may be referred to as a negative electrode, and the second electrode 20 may be referred to as a positive electrode.

The separator 30 may include a polymer material such as polyethylene (PE) or polypropylene (PP), and may insulate the first electrode 10 and the second electrode 20 while allowing the movement of lithium ions.

The lower case 131 may include a sealing portion 60 surrounding the receiver 50. The portions of the first and second lead tabs 14 and 24, respectively, may overlap the sealing portion 60, and the ends of the first and second lead tabs 14 and 24, respectively, may be exposed to the outside of the sealing portion 60. A protective tape 35 may be attached to the first and second lead tabs 14 and 24, respectively, that overlap the sealing portion 60.

After the electrode assembly 120 is accommodated in the receiver 50, the upper case 132 may overlap the lower case 131 and the electrode assembly 120 by folding, and the edge of the upper case 132 may be integrally joined with the sealing portion 60 by, for example, thermal fusion, thereby sealing the electrode assembly 120.

The case 130 may include a multi-layer structure including a metal sheet and a plurality of polymer sheets covering the inner and outer surfaces of the metal sheet. The metal sheet may be an aluminum sheet and may provide mechanical strength to the case 130. The polymer sheet may be at least one of a polyethylene terephthalate (PET) sheet, a nylon sheet, and a PET-nylon composite sheet, and may provide insulation and protection to the case 130.

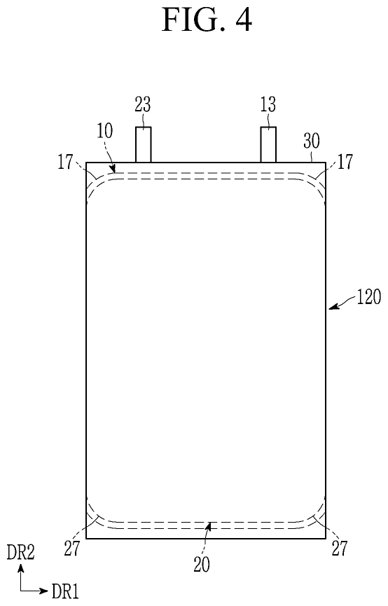

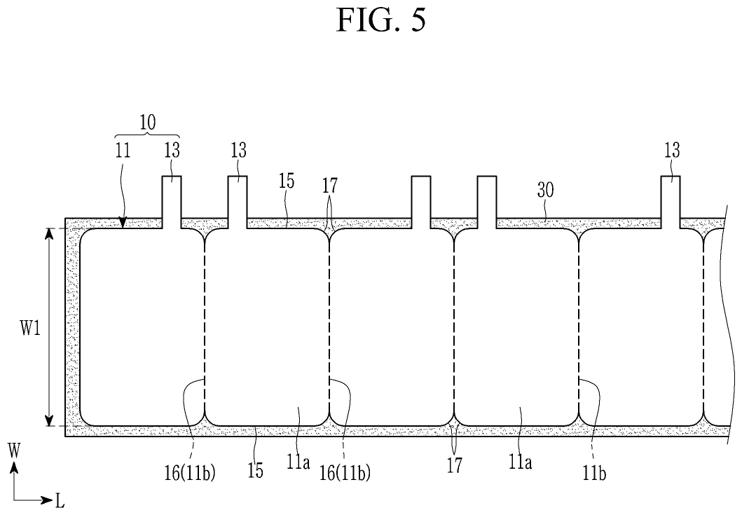

FIG. 4 is a plan view of an electrode assembly shown in FIG. 2 (omitting the protective tape 35, first lead tab 14 and second lead tab 24) according to one or more embodiments. FIG. 5 is a plan view showing an unfolded state of a first electrode among an electrode assembly shown in FIG. 4 according to one or more embodiments.

Referring to FIG. 2 to FIG. 6, the first substrate 11 may have a shape of a long band in the unfolded state, and may include a plurality of flat portions 11a corresponding to the central portion 121 and a plurality of curved portions 11b corresponding to the pair of rounded portions 122. The flat portions 11a and the curved portions 11b may be positioned alternately one by one along a length direction (L direction) of the first substrate 11. The first composite material layer 12 may be present on both surfaces of the first substrate 11 (e.g., flat portion 11a and the corresponding flat portion on the opposite side).

The first electrode tab 13 may protrude from the first substrate 11 to one side (in the orientation of FIG. 5, an upper side), and one first electrode tab 13 may be provided for each of the plurality of flat portions 11a. After the winding, the plurality of first electrode tabs 13 in the electrode assembly 120 may overlap each other and be fixed integrally by, for example, welding. The separator 30 may have a width greater than that of the first substrate 11 along a width direction (W direction) of the first substrate 11. That is, the upper and lower ends of the first substrate 11 may be positioned inside the separator 30.

The second substrate 21 has a long band shape in the unfolded state and may include a plurality of flat portions 21a corresponding to the central portion 121 and a plurality of curved portions 21b corresponding to the pair of rounded portions 122. The flat portion 21a and the curved portion 22b may be positioned alternately one by one along a length direction (L direction) of the second substrate 21. The second composite material layer 22 may be on both surfaces of the second substrate 21 (e.g., flat portion 21a and the corresponding flat portion on the opposite side).

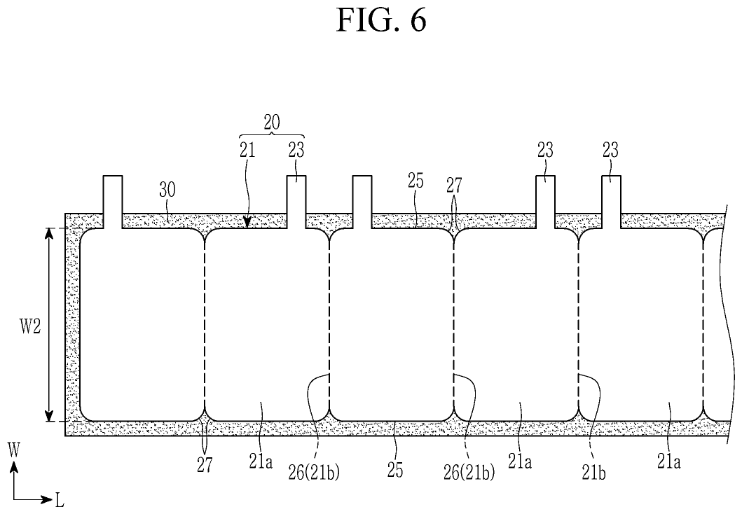

The second electrode tab 23 may protrude from the second substrate 21 to one side (in the orientation of FIG. 6, the upper side), and one second electrode tab 23 may be provided for each of the plurality of flat portions 21a. After the winding, the plurality of second electrode tabs 23 in the electrode assembly 120 may overlap each other and be fixed integrally, for example, by welding. The separator 30 may have a width greater than that of the second substrate 21 along a width direction (W direction W) of the second substrate 21. That is, the upper and lower ends of the second substrate 21 may be positioned inside the separator 30.

The first electrode tab 13 and the second electrode tab 23 may be offset from each other to avoid overlapping each other after the winding, and the width W1 of the first substrate 11 may be greater than the width W2 of the second substrate 21. If the rechargeable battery 100 is charged, lithium ions enter the inside of the first composite material layer 12, thereby causing the first composite material layer 12 to expand, and if it is discharged, the first composite material layer 12 contracts as the lithium ions leave the first composite material layer 12. As the lifespan of the rechargeable battery 100 increases, the first composite material layer 12 may be degraded due to repetitive volume changes. Therefore, considering this degradation, the first substrate 11 supporting the first composite material layer 12 may have the greater width than the second substrate 21.

In the first electrode 10, each edge of the plurality of flat portions 11a may be made up of the combination of the second straight portions 15 and 16 and a second curved portion 17. The second straight portion 15 and 16 may include a second horizontal portion 15 and a second longitudinal portion 16. The second horizontal portion 15 may be one edge where the first electrode tab 13 is positioned and the other edge is parallel thereto. The second longitudinal portion 16 may coincide with the curved portion 11b.

The second curved portion 17 may be positioned on at least two corners of the flat portion 11a. For example, two second curved portions 17 may be positioned on one (the upper) edge of the first substrate 11 in contact with the first electrode tab 13, or the second curved portion 17 may be positioned on each of four corners of the flat portion 11a. FIG. 5 shows the second case as an example.

The second curved portion 17 may have a circular arc shape with a predetermined curvature radius. The curvature center of the second curved portion 17 may be positioned within the corresponding flat portion 11a. Two second curved portions 17 positioned with the curved portion 11b in between may be symmetrical with respect to the curved portion 11b.

In the second electrode 20, each edge of the plurality of flat portions 21a may be made up of the combination of the third straight portion 25 and 26 and the third curved portion 27. The third straight portion 25 and 26 may include the third horizontal portion 25 and the third longitudinal portion 26, and the third longitudinal portion 26 may coincide with the curved portion 21b.

A third curved portion 27 may be positioned on at least two corners of the flat portion 21a. For example, two third curved portions 27 may be positioned on one (the upper) edge of the second substrate 21 in contact with the second electrode tab 23, or the third curved portion 27 may be positioned on each of the four corners of the flat portion 21a. FIG. 6 shows the second case as an example.

The third curved portion 27 may have a circular arc shape with a predetermined curvature radius, and the curvature center of the third curved portion 27 may be positioned within the corresponding flat portion 21a. Two third curved portions 27 positioned with the curved portion 21b in between may be symmetrical with respect to the curved portion 21b. The second curved portion 17 and the third curved portion 27 may have the same curvature radius, but are not limited thereto.

After the winding, the electrode assembly 120 may have a rectangular appearance in a plane view (if the target portion is viewed from above) by the separator 30, except for the first and second electrode tabs 13 and 23. The first electrode 10 may have an approximately rectangular shape in which the second curved portion 17 is positioned at four corners inside the edge of the separator 30. The second electrode 20 may have an approximate rectangle shape in which the third curved portion 27 is positioned at four corners inside the edge of the first electrode 10. Hereinafter, ‘on a plane’ means where the target part is viewed from above.

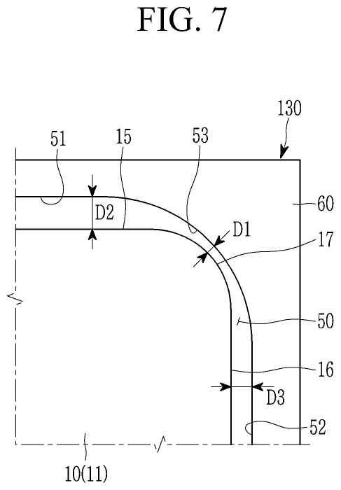

FIG. 7 is a partial enlarged view of a case and a first electrode of a rechargeable battery, as shown in FIG. 2 according to one or more embodiments.

Referring to FIG. 4 and FIG. 7, the edge of the receiver 50 of the case 130 may include the first straight portion 51 and 52 including the first horizontal portion 51 and the first longitudinal portion 52, and the first curved portion 53 positioned at the corner between the first horizontal portion 51 and the first longitudinal portion 52. The first horizontal portion 51 may be parallel to the second horizontal portion 15 where the first electrode tab 13 is positioned, and the first longitudinal portion 52 may be parallel to the second longitudinal portion 16. The first curved portion 53 may be a circular arc with a first curvature.

On the plane of the electrode assembly 120, the edge of the first electrode 10 may be made up of the combination of the second horizontal portion 15, the second longitudinal portion 16, and the second curved portion 17. The second curved portion 17 may be positioned at the edge between the second horizontal portion 15 and the second longitudinal portion 16. The second curved portion 17 may be composed of a circular arc with a second curvature. The curvature of the second curved portion 17 may be larger than the curvature of the first curved portion 53.

At the edge of the receiver 50 of the case 130, the first curved portion 53 and the second curved portion 17 may face each other. The minimum interval (a first interval D1) between the first curved portion 53 and the second curved portion 17 may be smaller than the interval between the first straight portion 51 and 52, and the second straight portion 15 and 16.

For example, if the interval between the first horizontal portion 51 and the second horizontal portion 15 is referred to as a second interval D2, and the interval between the first longitudinal portion 52 and the second longitudinal portion 16 is referred to as a third interval D3, the second interval D2 and the third interval D3 may be the same or different. In both cases, the first interval D1 may be smaller than the second interval D2 and the third interval D3.

In general, the second interval D2 between the second horizontal portion 15 connected to the first electrode tab 13 and the first horizontal portion 51 may be larger than the third interval D3. FIG. 7 shows the case in which the second interval D2 is larger than the third interval D3. Meanwhile, since the separator 30 has a larger area than the first electrode 10, it may come into contact with or overlap the sealing portion 60 of the case 130. Since the separator 30 is safe even if interference occurs with the sealing portion 60, the separator 30 is omitted in FIG. 7.

The configuration of the first electrode 10 described above serves to avoid interference between the first electrode 10 and the sealing portion 60, and simultaneously increases the capacity of the electrode assembly 120. The part where interference occurs with the sealing portion 60 in the electrode assembly 120 becomes the corner of the first electrode 10 closest to the sealing portion 60. As the first electrode 10 has the second curved portion 17 in the shape of the circular arc instead of a right-angled corner, it is possible to secure the minimum interval to avoid interference with the sealing portion 60 and simultaneously expand the size of the first electrode 10 along the width direction (the direction DR1 in FIG. 4) and the height direction (the direction DR2) of the electrode assembly 120.

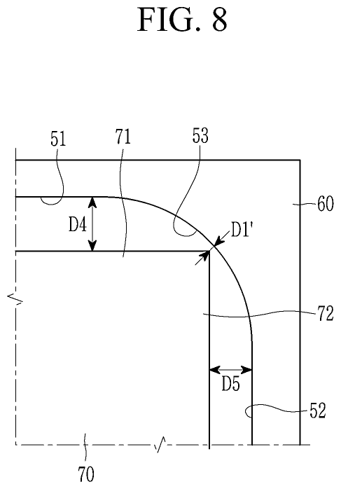

FIG. 8 is a partial enlarged view of a rechargeable battery according to a comparative example, and shows an enlarged corner of a case and a first electrode.

Referring to FIG. 7 and FIG. 8, in the electrode assembly of the comparative example, the first electrode 70 has a right-angled edge. Assuming that the edge of the first electrode 70 and the first curved portion 53 of the receiver 50 have an interval D1′ of the same size as the first interval D1 of FIG. 7, the interval D4 between the first horizontal portion 51 and the second horizontal portion 71 is greater than the second interval D2 of the embodiment, and the interval D5 between the first longitudinal portion 52 and the second longitudinal portion 72 is greater than the third interval D3 of the embodiment.

In both FIG. 7 and the comparative example of FIG. 8, the first electrodes 10 and 70 must maintain a certain distance from the sealing portion 60 to avoid heat damage during heat fusion of the sealing portion 60. In FIG. 7 and the comparative example of FIG. 8, if the receiver 50 in the case 130 has the same size and the same volume, the first electrode 10 of the embodiment has both the width (a width according to the direction DR1 in FIG. 4) and the height (a height according to the direction DR2 in FIG. 4) may be increased compared to the first electrode 70 in the comparative example due to the reduction of the distance from the sealing portion 60.

As a result, the electrode assembly 120 of FIG. 7 may increase the capacity of the first composite material layer 12 by expanding the size (and the area) of the first electrode 10 while avoiding interference of the first electrode 10 and the sealing portion 60. Additionally, the capacity of the second composite material layer 22 may be increased by expanding the size (and the area) of the second electrode 20 in response to the expanded size of the first electrode 10. In other words, the electrode assembly 120 of FIG. 7 may realize increased capacity compared to the comparative example of FIG. 8.

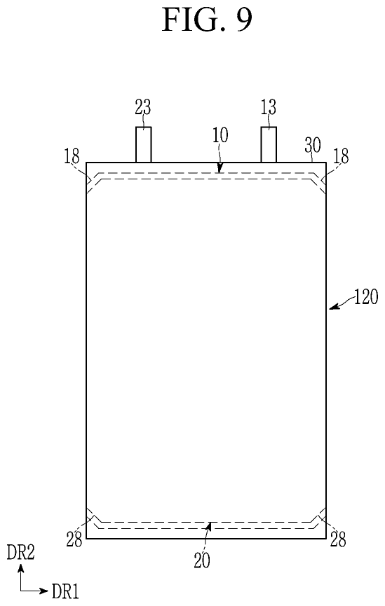

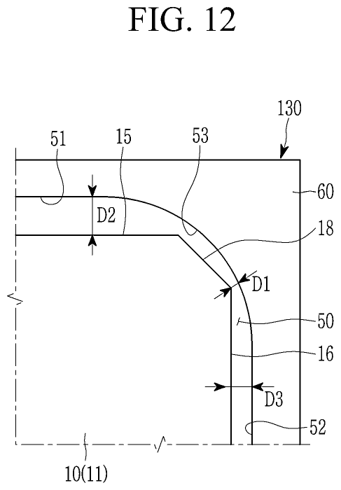

Table 1 below shows comparison results for the first electrode of the comparative example and the first electrode of three example embodiments with different curvature radius of the second curved portion. In Table 1, FIGS. 1 to 7 are referred to as “Embodiment 1,” FIG. 8 is referred to as the “comparative example,” FIGS. 9-11 are referred to as “Embodiment 2,” and FIG. 12 is referred to as “Embodiment 3.”

TABLE 1

| | Curvature | Longitudinal | | |
|---|---|---|---|---|
| | radius of second | width of | D1 and | D3 and |
| | curved portion | first electrode | D1′ | D5 |
| | (mm) | (mm) | (mm) | (mm) |
| Comparative | 0 | X | 0.22 | 0.75 |
| example | | | | |
| Embodiment 1 | 0.5 | X + 0.4 | 0.17 | 0.35 |
| Embodiment 2 | 1 | X + 0.5 | 0.24 | 0.25 |
| Embodiment 3 | 1.5 | X + 0.5 | 0.39 | 0.25 |

As shown in the table above, in the electrode assembly of Embodiments 1 to 3 having the second curved portion, the first interval D1 may have a larger value depending on the curvature radius of the second curved portion compared to the comparative example, but since the longitudinal width of the first electrode has a larger value than the comparative example in all three embodiments, the capacity of the electrode assembly may be increased.

On the other hand, Table 1 also corresponds to a case in which two second curved portions are positioned at the upper edges of the first substrate in contact with the first electrode tab. If the four second curved portions are positioned at each of the four corners (the upper and lower corners) of the first substrate, the longitudinal width of the first electrode is twice the result stated in Table 1.

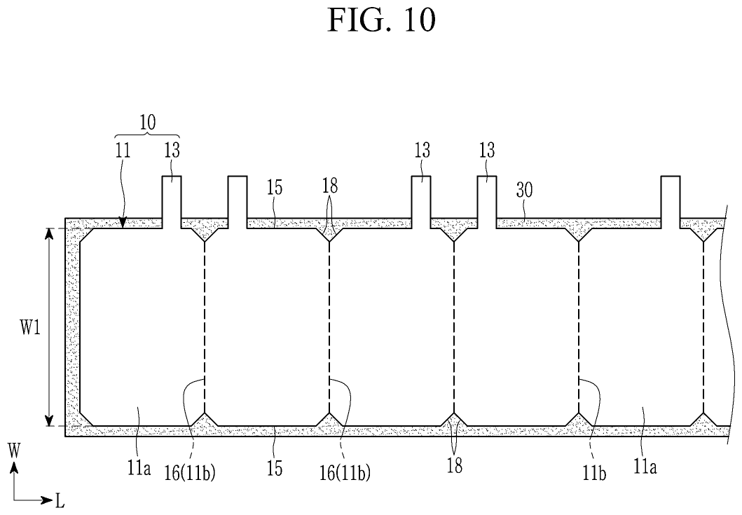

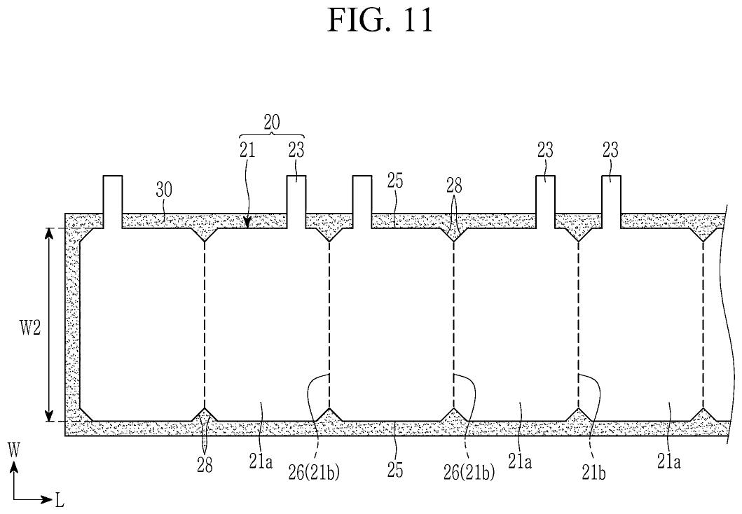

FIG. 9 is a plan view of an electrode assembly among rechargeable batteries according to one or more embodiments. FIG. 10 and FIG. 11 are plan views showing a first electrode and a second electrode among an electrode assembly shown in FIG. 9 in an unfolded state, respectively. The rechargeable battery of the second embodiment may have the same or a similar configuration as the first embodiment described above, except that the second curved portion and the third curved portion of the first embodiment are replaced with a first diagonal portion and a second diagonal portion described below.

Referring to FIG. 9 to FIG. 11, the first electrode 10 may include a first diagonal portion 18 positioned on at least two corners of the flat portion 11a. For example, two first diagonal portions 18 may be positioned on one (the upper) edge of the first substrate 11 in contact with the first electrode tab 13, or the first diagonal portion 18 may be positioned on each of four corners of the flat portion 11a. FIG. 10 shows the second case as an example.

The first diagonal portion 18 may have a diagonal shape forming an obtuse angle by the second horizontal portion 15 and the second longitudinal portion 16. Two first diagonal portions 18 positioned with the curved portion 11b in between may be symmetrical with reference to the curved portion 11b.

The second electrode 20 may include a second diagonal portion 28 positioned on at least two corners of the flat portion 21a. For example, two second diagonal portions 28 may be positioned on one (the upper) edge of the second substrate 21 in contact with the second electrode tab 23, or the second diagonal portion 28 may be positioned on each of four corners of the flat portion 21a. FIG. 11 shows the second case as an example.

The second diagonal portion 28 may have a diagonal shape forming an obtuse angle by the third horizontal portion 25 and the third longitudinal portion 26. Two second diagonal portions 28 positioned with the curved portion 21b in between may be symmetrical with reference to the curved portion 21b. The first diagonal portion 18 and the second diagonal portion 28 may have the same slope, but are not limited thereto.

After winding, the electrode assembly 120 may have a rectangular appearance on a plane by the separator 30, except for the first and second electrode tabs 13 and 23, respectively. The first electrode 10 may have an approximate octagonal shape with the first diagonal portion 18 positioned at four corners inside the edge of the separator 30. The second electrode 20 may have an approximately octagonal shape with the second diagonal portion 28 positioned at four corners inside the edge of the first electrode 10.

FIG. 12 is a partial enlarged view of a case and a first electrode of a rechargeable battery according to one or more embodiments (e.g., Embodiment 3 in Table 1).

Referring to FIG. 12, the edge of the receiver 50 of the case 130 may include a first horizontal portion 51, a first longitudinal portion 52, and a first curved portion 53. On the plane of the electrode assembly 120, the edge of the first electrode 10 may include a second horizontal portion 15, a second longitudinal portion 16, and a first diagonal portion 18.

The first diagonal portion 18 may face the first curved portion 53. The minimum interval (a first interval D1) between the first curved portion 53 and the first diagonal portion 18 may be smaller than the interval between an interval (a second gap D2) between the first horizontal portion 51 and the second horizontal portion 15 and an interval between the first longitudinal portion 52 and the second longitudinal portion 16 (a third interval D3).

In the rechargeable battery of the second embodiment, the first electrode 10 may have an area reduction at the corners of each flat portion 11a compared to the first electrode of the first embodiment, but the horizontal width and the height may be expanded compared to the first electrode of the comparative example. Additionally, since the horizontal width and the height of the second electrode 20 may be expanded corresponding to the enlarged size of the first electrode 10, the electrode assembly 120 of the second embodiment may realize increased capacity compared to the comparative example.

In the rechargeable battery of the above-described first and second embodiments, the second curved portion 17, the third curved portion 27, the first diagonal portion 18, and the second diagonal portion 28 may be referred to as corner deformed portions. The corner deformed portion is a corner where the horizontal portion and the longitudinal portion meet at a right angle are transformed into a shape other than a right angle by processing such as cutting. The second curved portion 17 and the third curved portion 27 correspond to a case in which a right-angled corner has been transformed into a rounded shape. The first diagonal portion 18 and the second diagonal portion 28 correspond to a case in which a right-angled corner has been chamfered in a diagonal direction.

The rechargeable battery of the first and second embodiments described above may increase the battery capacity by expanding the sizes of the first electrode 10 and the second electrode 20 while avoiding interference of the first electrode 10 and the sealing portion 60 by using the corner deformed portions.

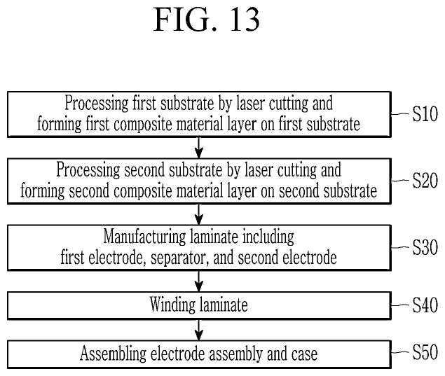

FIG. 13 is a flowchart showing a manufacturing method of a rechargeable battery according to one or more embodiments.

Referring to FIG. 13, a method of manufacturing a rechargeable battery includes manufacturing a first electrode (S10), manufacturing a second electrode (S20), manufacturing a laminate (S30), winding the laminate (S40), and assembling a case (S50). The process of manufacturing the laminate (S30) and the process of winding the laminate (S40) may be combined and referred to as an electrode assembly manufacturing process.

In the process of manufacturing the first electrode (S10), a plurality of first electrode tabs and a plurality of first corner deformed portions may be simultaneously formed by laser cutting a first metal foil. In the process of manufacturing the second electrode (S20), a plurality of second electrode tabs and a plurality of second corner deformed portions may be simultaneously formed by laser cutting a second metal foil.

Referring to FIG. 5 and FIG. 10, in the process of manufacturing the first electrode (S10), the first metal foil may be prepared, and the first metal foil may be processed into a first substrate 11 with the plurality of first electrode tabs 13 and the plurality of first corner deformed portions by a laser cutting. The first metal foil may be a copper foil or a nickel foil. The first corner deformed portions may include the second curved portion 17 shown in FIG. 5 or the first diagonal portion 18 shown in FIG. 10.

In a typical rechargeable battery, the first substrate 11 is manufactured by mechanical cutting using a cutter, but it is impossible to form a first corner deformed portion at each corner of the plurality of flat portions through such slitting straight line processing.

In the manufacturing method of the present embodiment, by applying a laser cutting processing instead of the slitting straight line processing, it is possible to easily form the first corner deformed portions in the shape of a curved line or a straight line for each corner of the plurality of flat portions 11a. A first composite material layer 12 may be provided on both surfaces of the first substrate 11, except for the first electrode tab 13, to form the first electrode 10.

Referring to FIG. 6 and FIG. 11, in the process of manufacturing the second electrode (S20), a second metal foil may be prepared, and the second metal foil may be processed into a second substrate 21 with a plurality of second electrode tabs 23 and a plurality of second corner deformed portions 27 and 28 by laser cutting. The second metal foil may be an aluminum foil. The second corner deformed portions 27 and 28 may include a third curved portion 27 shown in FIG. 6 or a second diagonal portion 28 shown in FIG. 11. A second composite material layer 22 may be provided on both surfaces of the second substrate 21, except for the second electrode tab 23, to form the second electrode 20.

In FIG. 13, for convenience, the process of manufacturing the second electrode (S20) is shown after the process of manufacturing the first electrode (S10), but, since the first electrode 10 and the second electrode 20 may be manufactured separately in separate processes, their order is not limited to the example shown.

Referring to FIG. 3, in the process of manufacturing the laminate (S30), the first electrode 10, the separator 30, the second electrode 20, and the separator 30 may be sequentially stacked to form the laminate 40. Referring to FIG. 5, FIG. 6, FIG. 10, and FIG. 11, the separator 30 may be made larger than the first substrate 11 and the second substrate 21, and surrounds and covers the entire first substrate 11 and the second substrate 21.

Referring to FIG. 2 and FIG. 3, in the process of winding the laminate (S40), the laminate 40 may be wound around the first winding axis AX1 and the second winding axis AX2 positioned at a distance from each other. Depending on the winding of the laminate 40, the electrode assembly 120 may have the appearance of a flat jelly roll.

The plurality of first electrode tabs 13 may be in close contact with each other by a pressing and fixed integrally by welding. The first lead tab 14 may be fixed to the first electrode tab 13 positioned on the outermost side by a method such as welding. The plurality of second electrode tabs 23 may be in close contact with each other by pressing and fixed integrally by welding. The second lead tab 24 may be fixed to the second electrode tab 23 positioned on the outermost side by a method such as welding.

Referring to FIG. 2, FIG. 7, and FIG. 12, in the process of assembling the case (S50), the electrode assembly 120 and the electrolyte may be accommodated in the receiver 50 of the lower case 131, and the upper case 132 may be folded by 180 degrees. The edges of the upper case 132 and the lower case 131 may be joined together by thermal fusion to form the sealing portion 60. The first electrode 10 may include the second curved portion 17 or the first diagonal portion 18 facing the first curved portion 53 of the edge of the receiver 50, and may be positioned on the receiver 50 to satisfy the above-mentioned interval condition (D1<D2, D1<D3).

According to embodiments, the electrode assembly of the rechargeable battery may increase the capacity of the first composite material layer by expanding the size of the first electrode while avoiding interference between the first electrode and the sealing portion of the case, and may increase the capacity of the second composite material layer by expanding the size of the second electrode in response to the expanded size of the first electrode. Therefore, the rechargeable battery of the present embodiment may implement increased battery capacity.

Embodiments of the present disclosure provide a rechargeable battery and a manufacturing method thereof that may increase the battery capacity by expanding the area of the electrode while avoiding interference between the electrode assembly and the case.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly including a first electrode and a second electrode stacked with a separator in between, and wound as a flat jelly roll; and
a case having a receiver for accommodating the electrode assembly and a sealing portion surrounding the receiver,
wherein an edge of the receiver includes a first straight portion and a first curved portion connected to the first straight portion and positioned at a corner,
wherein an edge of the first electrode on a plane of the electrode assembly includes a second straight portion, and a corner deformed portion connected to the second straight portion and facing the first curved portion, and
wherein a minimum interval between the first curved portion and the corner deformed portion is smaller than an interval between the first straight portion and the second straight portion.

2. The rechargeable battery as claimed in claim 1, wherein:
the first straight portion includes a first horizontal portion and a first longitudinal portion, the second straight portion includes a second horizontal portion and a second longitudinal portion, and the receiver and the first electrode satisfy conditions including:
D2>D3>D1,
wherein D1 is a minimum interval between the first curved portion and the corner deformed portion, D2 is an interval between the first horizontal portion and the second horizontal portion, and D3 is an interval between the first longitudinal portion and the second longitudinal portion.

3. The rechargeable battery as claimed in claim 2, wherein:
the corner deformed portion includes a second curved portion, and
a curvature of the second curved portion is larger than a curvature of the first curved portion.

4. The rechargeable battery as claimed in claim 3, wherein an edge of the second electrode on the plane of the electrode assembly includes a third curved portion positioned inside the second curved portion.

5. The rechargeable battery as claimed in claim 2, wherein the corner deformed portion includes a first diagonal portion.

6. The rechargeable battery as claimed in claim 5, wherein an edge of the second electrode on the plane of the electrode assembly includes a second diagonal portion positioned inside the first diagonal portion.

7. The rechargeable battery as claimed in claim 1, wherein:
the first electrode includes a first substrate,
the first substrate includes a plurality of flat portions and a plurality of curved portions positioned alternately one by one along a length direction, and
the corner deformed portion is positioned on at least two corners of each of the plurality of flat portions.

8. The rechargeable battery as claimed in claim 7, wherein:
a first electrode tab is connected to each of the plurality of flat portions, and
the corner deformed portion is provided at two corners positioned with the first electrode tab in between.

9. The rechargeable battery as claimed in claim 7, wherein the corner deformed portion is positioned at four corners of each of the plurality of flat portions.

10. The rechargeable battery as claimed in claim 1, wherein on the plane of the electrode assembly, the separator has a height greater than each of the first electrode and the second electrode, the separator surrounding the edge of the first electrode and an edge of the second electrode.

11. A method of manufacturing a rechargeable battery, the method comprising:
manufacturing a first electrode in which a first metal foil is processed into a first substrate having a plurality of first electrode tabs and a plurality of first corner deformed portions by laser cutting, and a first composite material layer is formed on both surfaces of the first substrate to form the first electrode;
manufacturing a second electrode in which a second metal foil is processed into a second substrate having a plurality of second electrode tabs and a plurality of second corner deformed portions by laser cutting, and a second composite material layer is formed on both surfaces of the second substrate to form the second electrode;
manufacturing an electrode assembly in which the first electrode and the second electrode are stacked with a separator in between and then wound to form the electrode assembly; and
assembling a case in which the electrode assembly is accommodated in a receiver of the case and the case is sealed.

12. The method of manufacturing the rechargeable battery as claimed in claim 11, wherein:
in manufacturing the first electrode, the first substrate includes a plurality of flat portions and a plurality of curved portions positioned alternately one by one along a length direction, and the plurality of first electrode tabs and the plurality of first corner deformed portions are positioned in each of the plurality of flat portions.

13. The method of manufacturing the rechargeable battery as claimed in claim 11, wherein:
in manufacturing the second electrode, the second substrate includes a plurality of flat portions and a plurality of curved portions positioned alternately one by one along a length direction, and the plurality of second electrode tabs and the plurality of second corner deformed portions are positioned in each of the plurality of flat portions.

14. The method of manufacturing the rechargeable battery as claimed in claim 11, wherein:
in assembling the case, an edge of the receiver includes a first straight portion and a first curved portion connected to the first straight portion and positioned at the edge, an edge of the first electrode on a plane of the electrode assembly includes a first corner deformed portion and a second straight portion connected to the first corner deformed portion, and the electrode assembly is accommodated in the receiver so that the first corner deformed portion faces the first curved portion at an interval.

15. The manufacturing method of the rechargeable battery as claimed in claim 14, wherein:
in manufacturing the first electrode, the first corner deformed portion includes one of a second curved portion and a first diagonal portion, and
in assembling the case, a minimum interval between the first curved portion and the first corner deformed portion is smaller than the interval between the first straight portion and the second straight portion.

16. The manufacturing method of the rechargeable battery as claimed in claim 15, wherein:
in manufacturing the second electrode, the second corner deformed portion includes one of a third curved portion and a second diagonal portion, and an edge of the second electrode is positioned inside the edge of the first electrode on the plane of the electrode assembly.
